(19) United States
(12) Patent Application Publication
(10) Pub. No.: US 2007/0025440 A1
(43) Pub. Date: Feb. 1, 2007

(54) Video encoding method and device

(76) Inventor: Stephan Oliver Mietens, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/578,072

(22) PCT Filed: Nov. 1, 2004
(86) PCT No.: PCT/IB04/03618

§ 371 Date: May 2, 2006

(30) Foreign Application Priority Data
Nov. 7, 2003 (EP) 03300205.6

(51) Int. Cl. H04N 11/04; H04N 11/02

(52) U.S. Cl. 375/240.03; 375/240.16; 375/240.24

(57) ABSTRACT

The invention relates to a video encoding method provided for encoding an input image sequence consisting of successive groups of frames in which each frame is itself subdivided into blocks, and to a corresponding video encoding device. This method and device perform the steps of preprocessing the sequence on the basis of a so-called content-change strength (CCS) computed for each frame, generating a predicted frame using motion vectors estimated for each block, applying to a difference signal between the current frame and the last predicted frame a transformation sub-step producing a plurality of coefficients and followed by a quantization sub-step of said coefficients, and coding said quantized coefficients. According to the invention, the CCS is used in the quantization sub-step for modifying the quantization factor used in this sub-step, the CCS and the quantization factor increasing or decreasing simultaneously.

### FIELD OF THE INVENTION

The present invention relates to a video encoding method provided for encoding an input image sequence consisting of successive groups of frames themselves subdivided into blocks, said method comprising the steps of:

preprocessing said sequence on the basis of a so-called content-change strength (CCS) computed for each frame by applying some predetermined rules;

estimating a motion vector for each block of the current frame;

generating a predicted frame using said motion vectors respectively associated to the blocks of the current frame;

applying to a difference signal between the current frame and the last predicted frame a transformation sub-step producing a plurality of coefficients and followed by a quantization sub-step of said coefficients;

coding said quantized coefficients.

Said invention is for instance applicable to video encoding devices that require reference frames for reducing e.g. temporal redundancy (like motion estimation and compensation devices). Such an operation is part of current video coding standards and is expected to be similarly part of future coding standards also. Video encoding techniques are used for instance in devices like digital video cameras, mobile phones or digital video recording devices. Furthermore, applications for coding or transcoding video can be enhanced using the technique according to the invention.

### BACKGROUND OF THE INVENTION

In video compression, low bit rates for the transmission of a coded video sequence may be obtained by (among others) a reduction of the temporal redundancy between successive pictures. Such a reduction is based on motion estimation (ME) and motion compensation (MC) techniques. Performing ME and MC for the current frame of the video sequence however requires reference frames (also called anchor frames). Taking MPEG-2 as an example, different frames types, namely I-, P- and B-frames, have been defined, for which ME and MC are performed differently: I-frames (or intra frames) are independently coded, by themselves, without any reference to past or future frames (i.e. without any ME and MC), while P-frames (or forward predicted pictures) are encoded each one relatively to a past frame (i.e. with motion compensation from a previous reference frame) and B-frames (or bidirectionally predicted frames) are encoded relatively to two reference frames (a past frame and a future frame). The I- and P-frames serve as reference frames.

In order to obtain good frame predictions, these reference frames need to be of high quality, i.e. many bits have to be spent to code them, whereas non-reference frames can be of lower quality (for this reason, a higher number of non-reference frames, B-frames in the case of MPEG-2, generally lead to lower bit rates). In order to indicate which input frame is processed as an I-frame, a P-frame or a B-frame, a structure based on groups of pictures (GOPs) is defined in MPEG-2. More precisely, a GOP uses two parameters N and M, where N is the temporal distance between two I-frames and M is the temporal distance between reference frames. For example, an (N,M)−GOP with N=12 and M=4 is commonly used, defining an “I B B B P B B B P B B B” structure.

Succeeding frames generally have a higher temporal correlation than frames having a larger temporal distance between them. Therefore shorter temporal distances between the reference and the currently predicted frame on the one hand lead to higher prediction quality, but on the other hand imply that less non-reference frames can be used. Both a higher prediction quality and a higher number of non-reference frames generally result in lower bit rates, but they work against each other since the frame prediction quality results from shorter temporal distances only.

However, said quality also depends on the usefulness of the reference frames to actually serve as references. For example, it is obvious that with a reference frame located just before a scene change, the prediction of a frame located just after the scene change is not possible with respect to said reference frame, although they may have a frame distance of only 1. One the other hand, in scenes with a steady or almost steady content (like video conferencing or news), even a frame distance of more than 100 can still result in high quality prediction.

From the above-mentioned examples, it appears that a fixed GOP structure like the commonly used (12, 4)-GOP may be inefficient for coding a video sequence, because reference frames are introduced too frequently, in case of a steady content, or at a unsuitable position, if they are located just before a scene change. Scene-change detection is a known technique that can be exploited to introduce an I-frame at a position where a good prediction of the frame (if no I-frame is located at this place) is not possible due to a scene change. However, sequences do not profit from such techniques if the frame content is almost completely different after some frames having high motion, with however no scene change at all (for instance, in a sequence where a tennis player is continuously followed within a single scene). A previous European patent application, already filed by the applicant on Oct. 14, 2003, with the filing number 03300155.3 (PHFR030124) has then described a new method for finding better reference frames. This method will be recalled below.

### SUMMARY OF THE INVENTION

It is therefore the object of the invention to propose a video encoding method based on said previous method for finding good frames that can serve as reference frames, but allowing to reduce more noticeably the coding cost.

To this end, the invention relates to a video encoding method such as defined in the introductory paragraph of the description and in which said CCS is used in said quantization sub-step for modifying the quantization factor used in said quantization sub-step, said CCS and said quantization factor increasing or decreasing simultaneously.

The invention also relates to a device for implementing said method.

### BRIEF DESCRIPTION OF THE DRAWINGS

The present invention will now be described, by way of example, with reference to the accompanying drawings in which:

FIG. 1 illustrates the rules used for defining, according to the description given in the previous European patent application cited above, the place of the reference frames of the video sequence to be coded;

FIG. 2 shows an encoder carrying out the encoding method described in said previous European patent application, taking the MPEG-2 case as an example;

FIG. 3 shows an encoder carrying out the encoding method according to the invention.

### DETAILED DESCRIPTION OF THE INVENTION

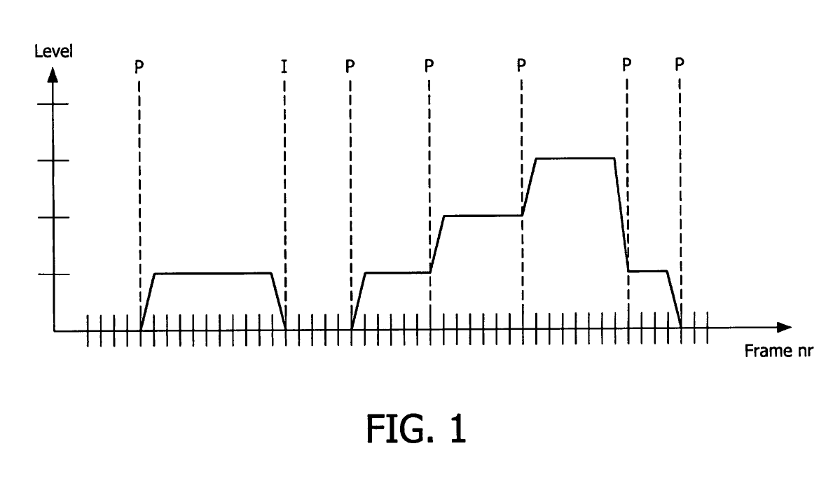

The document cited above describes a method for finding which frames in the input sequence can serve as reference frames, in order to reduce the coding cost. The principle of this method is to measure the strength of content change on the basis of some simple rules, such as listed below and illustrated in FIG. 1, where the horizontal axis corresponds to the number of the concerned frame and the vertical axis to the level of the strength of content change: the measured strength of content change is quantized to levels (for instance five levels, said number being however not a limitation), and I-frames are inserted at the beginning of a sequence of frames having content-change strength (CCS) of level 0, while P-frames are inserted before a level increase of CCS occurs or after a level decrease of CCS occurs. The measure may be for instance a simple block classification that detects horizontal and vertical edges, or other types of measures based on luminance, motion vectors, etc.

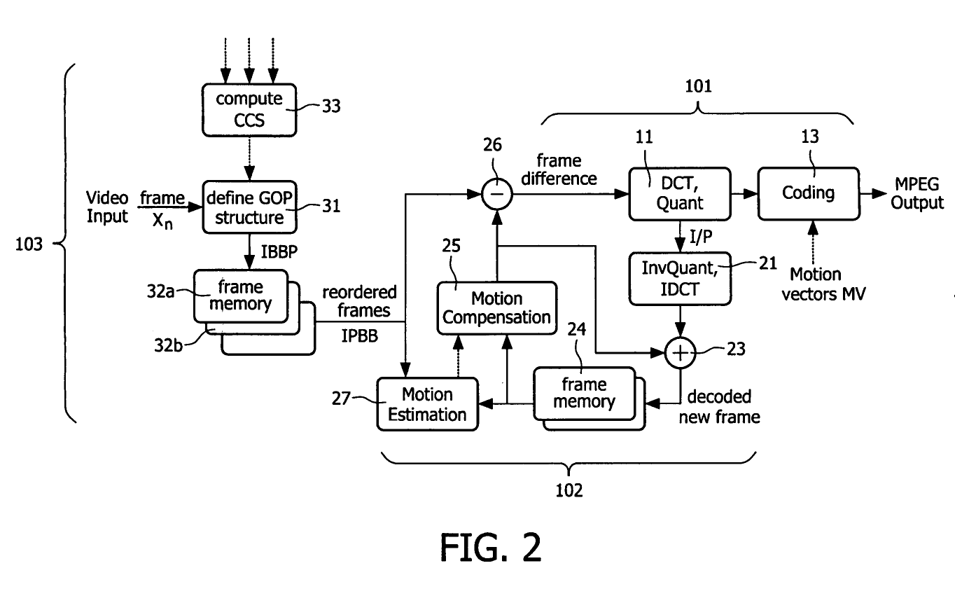

An implementation of this previous method in the MPEG encoding case is described in FIG. 2. The encoder comprises a coding branch 101 and a prediction branch 102. The signals to be coded, received by the branch 101, are transformed into coefficients and quantized in a DCT and quantization module 11, the quantized coefficients being then coded in a coding module 13, together with motion vectors MV. The prediction branch 102, receiving as input signals the signals available at the output of the DCT and quantization module 11, comprises in series an inverse quantization and inverse DCT module 21, an adder 23, a frame memory 24, a motion compensation (MC) circuit 25 and a subtracter 26. The MC circuit 25 also receives the motion vectors MV generated by a motion estimation (ME) circuit 27 (many types of motion estimators may be used) from the input reordered frames (defined as explained below) and the output of the frame memory 24, and these motion vectors are also sent towards the coding module 13, the output of which (“MPEG output”) is stored or transmitted in the form of a multiplexed bitstream.

The video input of the encoder (successive frames Xn) is preprocessed in a preprocessing branch 103. First a GOP structure defining circuit 31 is provided for defining from the successive frames the structure of the GOPs. Frame memories 32a, 32b . . . are then provided for reordering the sequence of I, P, B frames available at the output of the circuit 31 (the reference frames must be coded and transmitted before the non-reference frames depending on said reference frames). These reordered frames are sent on the positive input of the subtracter 26 (the negative input of which receives, as described above, the output predicted frames available at the output of the MC circuit 25, these output predicted frames being also sent back to a second input of the adder 23). The output of the subtracter 26 delivers frame differences that are the signals to be coded processed by the coding branch 101. For the definition of the GOP structure, a CCS computation circuit 33 is provided.

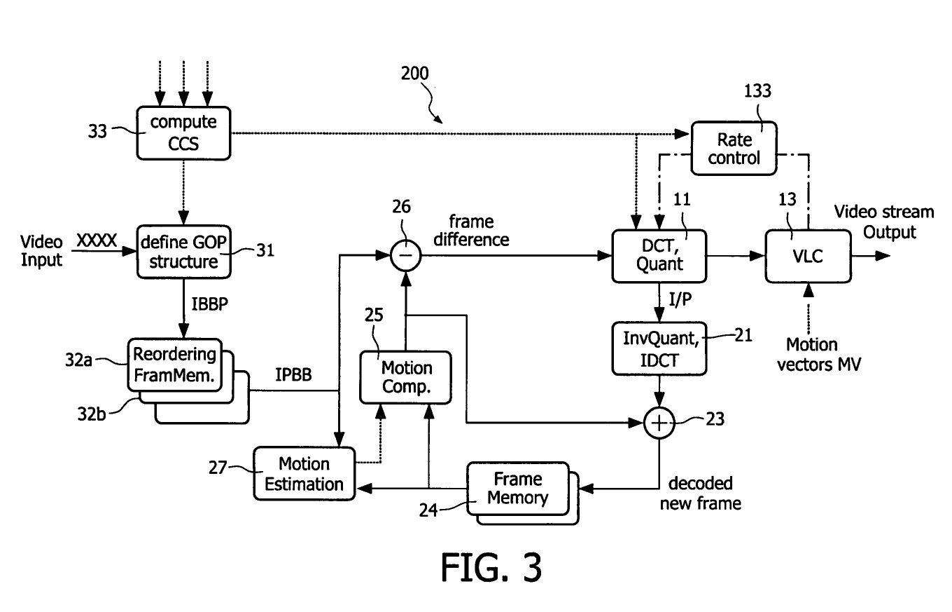

It has then been observed that the higher the CCS—which can result from motion—the less the viewer can really follow the presented video. It is consequently proposed, according to the present invention, to increase or decrease the quantization factor used in the module 11 as a function of the CCS—said CCS and the quantization factor increasing or decreasing simultaneously—which can be obtained by sending the output information of the CCS computation circuit towards the DCT and quantization module 11 of the coding branch. As described in the conventional part of FIG. 3 (said FIG. 3 is introduced in the next paragraph in relation with the description of the invention), it is known, indeed, that the coding module 13 is in fact composed of a variable-length coding (VLC) circuit arranged in series with a buffer memory, the output of said memory being sent back towards a rate control circuit 133 for modifying the quantization factor.

According to the invention, and as shown in FIG. 3 in which similar circuits are designated by the same references as in FIG. 2, an additional connection 200 intended to allow to implement the proposed modification of quantization factor is provided between the CCS computation circuit 33 and the rate control circuit 133 and also between said circuit 33 and the DCT and quantization module 11 of the coding branch. This connection 200 extends two coding modes of the coding system, namely a so-called open-loop coding mode (without bit-rate control) and a closed loop coding mode (with bit-rate control).

In the open-loop coding mode for example, the quantizer settings are usually fixed. The resulting bit rate of the encoded stream is automatically lower for simple scenes (less residue needs to be coded) than for complex scenes (higher residue needs to be coded). Coding cases as described above, where the sequence contains high motion, result in complex scenes that are coded with high bit-rates. The bit-rates for the high-motion scenes can be reduced by higher quantization, thereby removing spatial details of these scenes that the observer cannot follow due to the motion. The quantization can be controlled by defining a quantization factor, q_ccs, which is a function of CCS and the original fixed quantizer factor, called q_fixed:

q_ccs=q_fixed+f(CCS),

where f( ) is a function resulting in positive integers 0 . . . (q_max-q_fixed) to increase q cs from q_fixed upto an allowed maximum q_max. Examples for f( ) are f1 (CCS)=round (CCS*(q_max-q_fixed)/(CCS_max)) or f1(CCS)=round ((q_max-q_fixed+1)ˆ(CCS/CCS_max)−1) for CCS=0 to CCS_max.

In closed-loop coding, the quantization factor, q_adapt, is adapted in order to achieve a desired predefined bit rate. Bit-rate controllers that are required for closed-loop coding work basically with bit budgets and chose q_adapt based on the available budget. This means that the quantization factor q_css as described for open-loop coding can be used, and only q_fixed has to be replaced with q_adapt. Then, compared to an unmodified rate controller, the bit budget will increase with higher CCS, and these additional bits are automatically spent on frames with lower CCS, because the q_adapt value will decrease due to the increased bit budget.

1. A video encoding method provided for encoding an input image sequence consisting of successive groups of frames themselves subdivided into blocks, said method comprising the steps of:
preprocessing said sequence on the basis of a so-called content-change strength (CCS) computed for each frame by applying some predetermined rules;
estimating a motion vector for each block of the frames;
generating a predicted frame using said motion vectors respectively associated to the blocks of the current frame;
applying to a difference signal between the current frame and the last predicted frame a transformation sub-step producing a plurality of coefficients and followed by a quantization sub-step of said coefficients;
coding said quantized coefficients;
wherein said CCS is used in said quantization sub-step for modifying the quantization factor used in said quantization sub-step, said CCS and the quantization factor increasing or decreasing simultaneously.

2. A video encoding device provided for encoding an input image sequence consisting of successive groups of frames themselves subdivided into blocks, said device comprising the following means:
preprocessing means, provided for preprocessing said sequence on the basis of a so-called content-change strength (CCS) computed for each frame by applying some predetermined rules;
estimating means, provided for estimating a motion vector for each block of the frames;
generating means, provided for generating a predicted frame on the basis of said motion vectors respectively associated to the blocks of the current frame;
transforming and quantizing means, provided for applying to a difference signal between the current frame and the last predicted frame a transformation producing a plurality of coefficients and followed by a quantization of said coefficients;
coding means, provided for encoding said quantized coefficients;
wherein an output of said preprocessing means is received on an input of said transformation and quantization means for modifying on the basis of said CCS the quantization factor used in said quantization sub-step, said CCS and the quantization factor increasing or decreasing simultaneously.
